(19) United States
(12) Patent Application Publication
(10) Pub. No.: US 2009/0187981 A1
(43) Pub. Date: Jul. 23, 2009

(54) FILE DOWNLOADING SERVER AND METHOD

(75) Inventors: ZAI-AN PAN, Shenzhen City (CN); BING LI, Shenzhen City (CN); DUO LIU, Shenzhen City (CN); HAN-CHE WANG, Tu-Cheng (TW)

Correspondence Address: PCE INDUSTRY, INC.;ATT. Steven Reiss, 458 E. LAMBERT ROAD, FULLERTON, CA, 92835, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/177,104

(22) Filed: Jul. 21, 2008

(30) Foreign Application Priority Data
Jan. 18, 2008 (CN) 200810065934.8

(51) Int. Cl. G06F 7/58

(52) U.S. Cl. 726/7

(57) ABSTRACT

A method for downloading files from a server is provided. The method includes the steps of: receiving a registered account and a password; determining whether the current user is an authorized user of the server; reading a terminal ID of a terminal when the user is an authorized user; displaying files whose download status are to-be-downloaded status when the read terminal ID matches the corresponding terminal ID of the registered account; recording the selected files and delivering the selected files to the corresponding terminal; and updating information in relation to the files that are viewed by the registered account in the file list and updating the download status of the viewed files to the to-be-downloaded status when the read terminal ID does not match the corresponding terminal ID of the registered account, and updating the download status of the files to the downloaded status when the files are downloaded to the terminal.

### BACKGROUND

1. Field of the Invention

The present invention relates to a file download server and method.

2. Description of the Related Art

Networked servers provide abundant information for users. A user can find a lot of needed information such as music, film, technology data on different servers through networks. When searching for the needed information on a certain server, sometimes, one may want to download and save the needed information on to one's own terminal. If his/her own terminal is used, the needed information can be download directly to his/her own terminal. However, a user may not be allowed to do so if he or she is using others' terminal. Although the server can keep the needed information that a registered user has viewed via different terminal, both his/her own or the other's, it cannot remind the user what's the needed information that views via other terminals and haven't been downloaded to the user's own terminal when the user accesses the server via his/her own terminal. Therefore the user should research the needed information in all information the user viewed via different terminals recorded in the server. Thus is inefficiency.

Therefore, what is needed is a file downloading server and method which can improve downloading efficiency and provides convenience for users.

### SUMMARY

A method for downloading files from a server is provided. The method comprises: providing a database in the server, wherein the database comprises a file list and a plurality of files, the file list is configured for recording relationships between an account which user registers to the server, a terminal ID of a terminal connected to the server, information in relation to the files which the user viewed in the server, and download status of the files, wherein the download status comprise a downloaded status and a to-be-downloaded status; receiving a registered account and a password input by a current user; determining whether the current user is an authorized user of the server according to the input registered account ID and password; reading the terminal ID of the terminal when the user is the authorized user; displaying the files whose download status are to-be-downloaded status when the read terminal ID matches the corresponding terminal ID of the registered account in the file list; recording the files which the user selected from the displayed files and delivering the selected files to the corresponding terminal; and updating the information in relation to the files that are viewed by the registered user in the file list and updating the download status of the viewed files to the to-be-downloaded status when the read terminal ID does not match the corresponding terminal ID of the registered account in the file list, and updating the download status of the files to the downloaded status when the files are downloaded to the terminal.

Other advantages and novel features will be drawn from the following detailed description of the preferred embodiments with reference to the attached drawings.

### BRIEF DESCRIPTION OF THE DRAWINGS

The components of the drawings are not necessarily drawn to scale, the emphasis instead being placed upon clearly illustrating the principles of a file downloading server. Moreover, in the drawings, like reference numerals designate corresponding parts throughout several views.

FIG. 1 is a block diagram of an file downloading server in accordance with an exemplary embodiment of the present invention.

FIG. 2 is a flowchart of a method for downloading file from the server of FIG. 1, according to another exemplary embodiment.

### DETAILED DESCRIPTION OF THE EMBODIMENTS

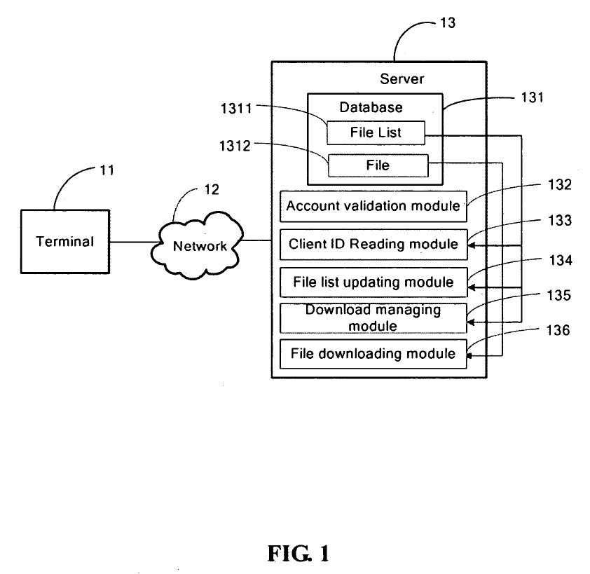

FIG. 1 is a block diagram of a file downloading server (hereinafter “the server”) in accordance with an exemplary embodiment of the present invention. The server 13 connects with a terminal 11 via a network 12. The terminal 11 can be a personal computer, a laptop, an electronic-book, a media player, or other electronic apparatuses that can execute media files or text files. The network can be the Internet or a wireless network such as a general packet radio service (GPRS).

The server 13 includes a database 131. The database 131 is configured for storing a file list 1311 and a plurality of files 1312 such as media files or text files. The file list 1311 records files that have been viewed by different registered users with a valid account for the service. Each of the accounts corresponds to a valid user of the server 13. The file list 1311 includes an account column, a terminal identifier (ID) column, a filename column, a file location column, and a file status column. An entry in the account column records the login account which the user registered in the server 13. An entry under the terminal ID column records a terminal ID of each terminal 11. The terminal ID is an unique identifier of each terminal 11. An entry under the filename column records filenames of the files viewed via the terminal. The file address column records file path of corresponding files 1312 in the database 131 or uniform resource locators (URL) of the files 1312. The download status column records download status of the files 1312. The download status may include a downloaded status, a to-be-downloaded status, and a not-needed status. The downloaded status represents that the corresponding file has been downloaded to a predetermined terminal 11. The to-be-downloaded status represents the corresponding file needs to be downloaded to the predetermined terminal 11. The not-needed status represents that the corresponding file is not wanted, thus does not have to be downloaded to the predetermined terminal 11. There are two situations that can be regarded as the corresponding file is not wanted. One situation is after viewing the files 1312, the user does not select the files to be downloaded to the predetermined terminal 11. The other situation is after logging on the server 13, the user does not select the files that are displayed for selection.

File List

| | Terminal | File | File | |
|---|---|---|---|---|
| Account | ID | name | address | Download status |
| Lovelybaby | XXXXX1 | File A | xxxxxxxx | Downloaded |
| | | File B | xxxxxxxx | To-be-downloaded |
| | | File C | xxxxxxxx | Not-needed |
| | | . . . | . . . | |
| Badboy | XXXXX2 | File D | xxxxxxxx | Not-needed |
| | | File E | xxxxxxxx | Downloaded |
| | | File F | xxxxxxxx | To-be-downloaded |
| . . . | . . . | . . . | . . . | . . . |

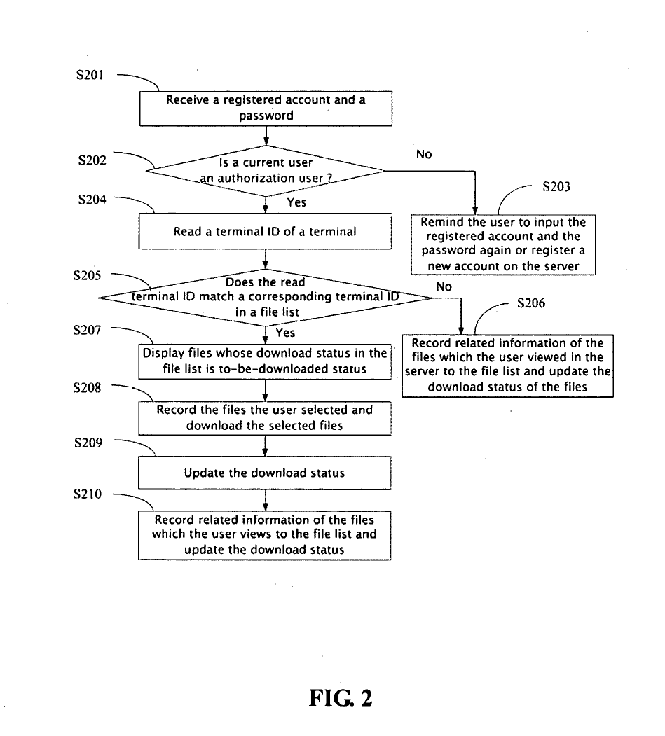

The server 13 includes an account validation module 132, a terminal ID reading module 133, a file list updating module 134, a download managing module 135, and a file downloading module 136. Functions implemented by these modules of the server 13 can be referred to in FIG. 2 as described below.

FIG. 2 is a flowchart of a method for downloading files from the server 13, according to another exemplary embodiment, to a corresponding terminal 11. In step S201, the account validation module 132 receives a registered account and a password via the terminal 11.

In step S202, the account validation module 132 determines whether the login information is valid by comparing the registered account and password input by the current user against the file list 1311.

If the login information is invalid, i.e. the use is not an authorized user, in step S203, the account validation module 132 reminds the user to input the registered account and the password again or reminds the user to register a new account on the server 13.

If the user is an authorized user of the server 13, in step S204, the terminal ID reading module 133 reads the terminal ID of the terminal 11.

In step S205, the terminal ID reading module 133 determines whether read terminal ID matches a corresponding terminal ID of the registered account in the file list 1311.

If the read terminal ID does not match the corresponding terminal ID of the registered account in the file list 1311, in step S206, the file list updating module 134 records information in relation to viewed files in the file list 1311, such as a file name and a file address, and updates the download status of the viewed files in the file list 1311 to the “to-be-downloaded” status.

If the read terminal ID matches the corresponding terminal ID of the registered account in the file list 1311, in step S207, the download managing module 135 displays the files whose download status is the “to-be-downloaded” status in the file list 1311.

In step S208, the file downloading module 136 records the files 1312 that the user selects from the displayed files, and delivers the selected files to the terminal 11 according to the corresponding file addresses recorded in the file list 1311 in response to a download operation from the user.

In step S209, the file list updating module 134 updates the download status of the files 1312 which are selected and downloaded to the “downloaded” status in the file list 1311, and updates the files 1312 which are displayed but not selected to be downloaded to the “no-need-to-be-downloaded” status.

In step S210, when the user views files on the server 13 again, the file list updating module 134 records information in relation to the viewed files to the file list 1311, and updates the download status of the files 1312 which the user views and downloads to “downloaded” status, and updates the download status of the files which the user views but not downloads to “no-need-to-be-downloaded” status.

In another preferred embodiment of this invention, when the download managing module 135 displays the files whose download status is the “to-be-downloaded” status in the file list, the server 13 provides an all file display function. When the all file display function is implemented, the download managing module 135 displays all the files corresponding to the account in the file list 1311 for user to select, and updates the download status of the files to the “downloaded status” when the files 1312 are downloaded.

Although the present invention has been specifically described on the basis of the preferred embodiments, the invention is not to be construed as being limited thereto. Various changes or modifications may be made to the embodiment without departing from the scope and spirit of the invention.

What is claimed is:

1. A file downloading server, comprising:
a database for storing a file list and a plurality of files, wherein the file list is configured for recording relationships between an account which a user registers with the server, a terminal ID of a terminal connected to the server, information in relation to the files which the user viewed in the server, and download status of the files, wherein the download status comprise a downloaded status and a to-be-downloaded status;
an account validation module for receiving a registered account and a password via the terminal and determining whether a current user is an authorized user of the server according to the registered account and password;
a terminal ID reading module for reading the terminal ID of the terminal when the account validation module determines the current user is an authorized user;
a download managing module for displaying the files whose download status are to-be-downloaded status when read terminal ID matches a corresponding terminal ID of the registered account in the file list;
a file downloading module for recording the files which the user selected from the displayed files and delivering the selected files to the corresponding terminal; and
a file list updating module for updating the information in relation to the files that are viewed by the registered user in file list and updating the download status of the viewed files to the to-be-downloaded status when the read terminal ID does not match the corresponding terminal ID of the registered account in the file list, and updating the download status of the files to the downloaded status when the files are downloaded to the terminal.

2. The server as described in claim 1, wherein the information in relation to the files comprises a file name and a file address, the file address records a file path of the files stored in the server or a uniform resource locator (URL) of the files, and the file downloading module delivers the files according to the file address.

3. The server as described in claim 1, wherein the download status further comprises a no-need-to-be-downloaded status, after the files are viewed but not downloaded or after the files are displayed but not downloaded, the download status updating module being capable of updating the downloading status of the files to the no-need-to-be-downloaded status.

4. A method for downloading files from a server, comprising:
providing a database in the server, wherein the database comprises a file list and a plurality of files, the file list is configured for recording relationships between an account which a user registers to the server, a terminal ID of a terminal connected to the server, information in relation to the files which the user viewed in the server, and download status of the files, wherein the download status comprise a downloaded status and a to-be-downloaded status;
receiving a registered account and a password input by a current user;
determining whether the current user is an authorized user of the server according to the input registered account and password;
reading the terminal ID of the terminal when the user is an authorized user;
displaying the files whose download status are to-be-downloaded status when the read terminal ID matches the corresponding terminal ID of the registered account in the file list;
recording the files which the user selected from the displayed files and delivering the selected files to the corresponding terminal; and
updating the information in relation to the files that are viewed by the registered user in the file list and updating the download status of the viewed files to the to-be-downloaded status when the read terminal ID does not match the corresponding terminal ID of the registered account in the file list, and updating the download status of the files to the downloaded status when the files are downloaded to the terminal.

5. The method as described in claim 4, wherein the download status further comprises a no-need-to-downloaded status, the updating step further comprises updating the downloading status of the files to no-need-to-be-downloaded status after the files are not selected to be downloaded to the corresponding terminal, or the displayed files are not selected to be downloaded after the user logs on the server according to the registered account.
